(19) United States
(12) Patent Application Publication
(10) Pub. No.: US 2004/0178879 A1
(43) Pub. Date: Sep. 16, 2004

(54) Micromachined heaters for microfluidic devices

(76) Inventors: Somenath Mitra, Bridgewater, NJ (US); Durgamadhab Misra, Basking Ridge, NJ (US)

Correspondence Address: KAPLAN & GILMAN , L.L.P., 900 ROUTE 9 NORTH, WOODBRIDGE, NJ, 07095, US

(21) Appl. No.: 10/735,989

(22) Filed: Dec. 15, 2003

Related U.S. Application Data
(60) Provisional application No. 60/433,184, filed on Dec. 13, 2002.

(51) Int. Cl. H01C 7/00

(52) U.S. Cl. 338/34

(57) ABSTRACT

Microfabricated heaters for microfluidic devices for lab-on-a-chip applications comprising channels using deposited conductors such as sputtered metal, alloys, polymers and composites thereof; or conductors prepared by ion implantation, and methods for fabricating same are disclosed. Rapid heating to temperatures above 360° C. and rapid cooling is possible using these microheaters. Repeated heating does not lead to the microheater devices weakening or burning out. Preferred embodiments include application of spin-on-glass on the microheater surface.

### RELATED APPLICATIONS

This application claims the benefit of U.S. Provisional Application No. 60/______, filed Dec. 13, 2002, entitled “Micromachined Heater for Microfluidic Devices,” Docket No. 02-05 (PROV) with named inventors Somenath Mitra, Minhee Kim and Durgamadhab Misra, the entirety of which is incorporated herein by reference.

### FIELD OF THE INVENTION

The present invention relates to microheaters, specifically, microheaters for microfluidic devices.

### BACKGROUND OF THE INVENTION

Microfluidic devices are used in various applications such as chemical analysis, reaction engineering, drug discovery, electronics chip cooling, flow sensors and biomedical devices. Microfluidics are also being employed in separation techniques such as gas chromatography, liquid chromatography, and electrophoresis. In fact, it has been demonstrated that it is possible to put a conventional chemical laboratory onto a single microchip to produce large numbers of parallel analysis. Performance enhancement, high throughput, low power consumption, reduction of the sample size, and low cost are some of the advantages of such miniaturized devices. Moreover, the combination of chemical analysis and traditional electronics on a single silicon chip can lead to rapid and inexpensive manufacturing processes. Noteworthy among the different applications is microfabricated capillary electrophoresis for DNA sequencing.

Many microfluidic devices require technologies for temperature control because reactions and sample preparations need to be carried out at higher temperatures. It is often important to maintain a particular area of a working element heated while the rest of the system is at a lower temperature. For example, Polymerase Chain Reaction (PCR) for DNA amplification would require fast temperature cycling. The need for local microheating and maintaining a constant temperature necessitates the development and fabrication of efficient microscaled heaters.

Microheating elements of the prior art have been made either by the deposition of polysilicon layer or by heavy doping of the silicon substrate. Many of the current microheaters use fabrication techniques in which a selective etch of the bulk silicon followed by implantation of high concentration of dopants (typically the range of the ion dose is between 10¹⁹ to 10²¹ atoms/cm³) to achieve a higher level of electrical conductivity of the heater region. Single-crystal silicon cantilevers with integrated resistive heaters have also been demonstrated. These cantilevers were made electrically conductive by a heavy ion implant. The heater region was doped with phosphorous at 1.5×10²¹ atoms/cm³ and the legs at 10²⁰ atoms/cm³. Ion implantation over a device allows the option of further anisotropical etching of the underlying substrate while providing localized heating. However, heavy ion implantation is an expensive process.

Silicon-on-insulator (SOI) technology is another way of fabricating microheaters and is known to be simpler than either deposition of polysilicon layers, or the heavy doping of silicon. A thermally isolated microheater suspended 2 μm above the wafer substrate has been fabricated using a SOI wafer with a 2 μm buried oxide layer on silicon substrate. This method is simpler than the other methods because it involves only one masking step. However, it also requires heavy boron or phosphorous doping to form the conductive layer (approximately >10¹⁹ atoms/cm³). Experimental results obtained using these devices have shown that temperatures in excess of 1000° C. can be achieved at low power. The heaters can be as small as 500 μm². It has also been demonstrated that these heaters reduce contact resistance so that there is less unwanted heating at the contacts. However, once the maximum temperature is reached, any further increase in current only broadens the active area of the heating element. Thus, continued operation in this region leads to device weakening and eventually device burn out.

To date, however, no microheater that is an integral part of a microchannel has been provided in a microfluidic device.

### SUMMARY OF THE INVENTION

Development of lab-on-a-chip requires microheaters to carry out reactions and sample preparation at microscale. The present invention provides heated microchannel devices and processes for the fabrication of same by forming a microchannel and depositing in said microchannel a conductor such as but not limited to a metal, alloy, polymer or polymer/alloy composite, or alternatively, by ion implantation, to form a resistive heater. In a preferred embodiment the microchannel microheater devices are fabricated on a silicon substrate via conventional oxidation, photolithography, chemical wet etching, and metal deposition or ion implantation steps. Rapid heating to temperatures above 360° C. and rapid cooling is possible using these microheaters. Repeated heating does not lead to the microheater devices weakening or burning out. Preferred embodiments include application of glass on the microheater surface for applications such as electrophoresis and chromatography.

### OBJECTS OF THE INVENTION

It is therefore an object of the present invention to provide a microheater device for microfluidic applications and in particular heated microchannels for devices such as microreactors, lab-on-a-chip applications, microfuel cells and the like.

It is a further object of the present invention to provide a microheater device for microfluidic applications employing a metal, alloy or conducting polymer or polymer composite as the heating element.

It is still a further object of the present invention to provide a microheater device for microfluidic applications employing a heating element fabricated at least in part by doping by processes such as ion implantation by boron.

It is another object of the present invention to provide a microheater device for microfluidic applications in which the heating element allows in-situ heating of the channel only and does not require the heating of the whole chip bulk.

It is yet another object of the present invention to provide a microheater device for microfluidic applications in which the heater is further covered with a substrate onto which adsorbents, catalysts, particles, polymers, reactants, enzymes, proteins, cells and the like can be deposited.

It is a further object of the present invention to provide a microheater device for microfluidic applications in which the heater can be used to heat materials, fluids for reactions, for breaking/lysing cells, and also carrying out reactions.

It is yet a further object of the present invention to provide a microheater device for microfluidic applications in which the thickness of the heating element is optimized to provide a particular range of temperatures.

It is yet a further object of the present invention to provide a method for fabricating a microheater device for microfluidic applications.

These and other objects will be apparent to those having skill in the art.

### BRIEF DESCRIPTION OF THE DRAWINGS

FIGS. 1A-1E reflect a step-by-step graphical depiction, in cross-section, of a preferred embodiment of a microheater fabricated in accordance with a method of the present invention.

FIG. 2A-2E reflect a step-by-step graphical depiction, in cross-section, of a preferred embodiment of a microheater fabricated in accordance with a method of the present invention.

FIG. 3 is a top view of a preferred embodiment of heating channels in accordance with the present invention.

FIG. 4 is a perspective view of a cross section of an isotropically etched portion of a microheater in accordance with a preferred embodiment of the present invention.

FIG. 5 is a graphical representation of a temperature profile of an embodiment of the present invention.

FIG. 6 is a graphical representation of temperature characteristics of an embodiment of the present invention.

FIG. 7 is a graphical representation of a current profile for voltage pulses to a device according to an embodiment of the present invention.

FIG. 8 is a schematic diagram of a heater used in modeling in accordance with the teachings of the present invention.

FIGS. 9-13 are graphical representations of calculated temperatures as a function of various characteristics in accordance with the present invention.

### DETAILED DESCRIPTION OF THE PREFERRED EMBODIMENT

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in one embodiment” in various places in the specification are not necessarily all referring to the same embodiment.

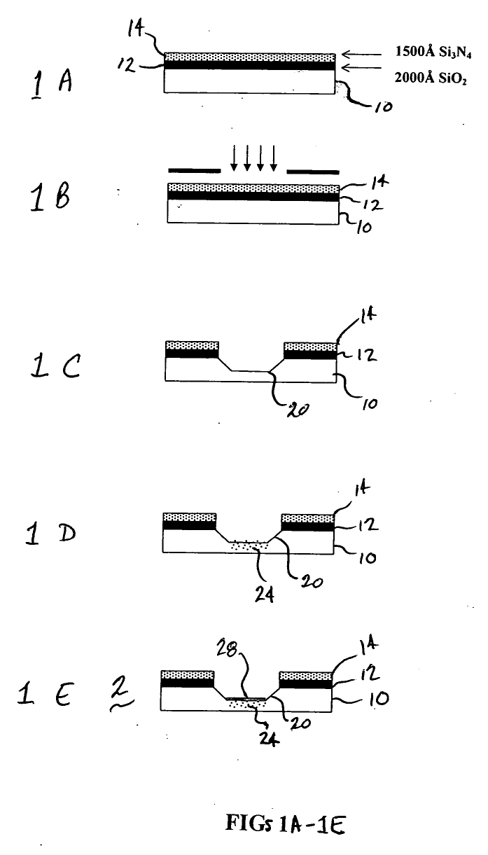

Now referring to FIG. 1 a preferred embodiment of a method for preparing a microheater 2 for a microfluidic device according to the present invention is disclosed. Wafer 10 may comprise a commercially available material commonly used for photolithographic fabrication such as but not limited to quartz or borosilicate glass. Quartz is a desirable material in electrophoresis because it is a good electrical insulator and is transparent to the UV required for absorbance and fluorescence detection. Quartz substrates also generate high electroosmotic flow rates and have favorable surface characteristics after fabrication by etching. Silicon is also desirable in microfluidic applications because it is possible to embed both fluid-control and fluid detection by integrated circuits on one substrate. By way of comparison the typical fluidic devices such as microreactors and microfluidic capillaries are 2-3 cm² in size, and are made of silicon, glass, quartz, or plastic that are either etched, microimprinted or molded. The etched channels and chambers are usually covered with Pyrex, glass or silicon to contain the sample and the reagent. In a preferred embodiment wafer 10 comprises an oriented, p-typed (boron doped), single side polished silicon wafer with a thickness of 575 μm and a resistivity of 10-25-cm.

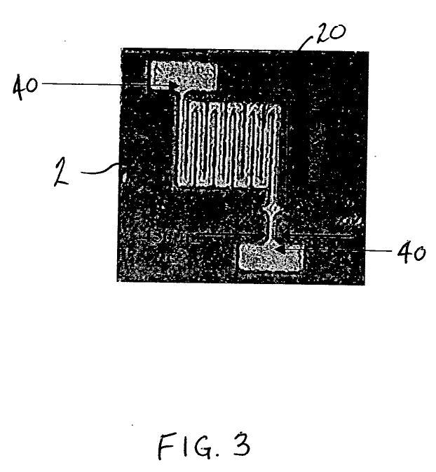

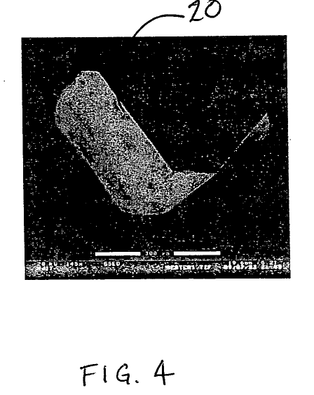

Now referring to FIG. 1A wafer 10 is preferably prepared by steam oxidation to grow the oxide layer (SiO₂) 12 to a thickness of 2000 Å. This step is followed by LPCVD (low pressure chemical vapor deposition) to deposit the silicon nitride layer (Si₃N₄) 14 in a thickness of 1550 Å. Now referring to FIG. 1B the wafer 10 is patterned using standard UV lithography. Preferably the patterned wafers are etched using Reactive Ion Etching (RIE), a combination of plasma etching that has the major advantage of etching the silicon dioxide over the silicon layers. Now referring to FIG. 1C the wafer is next anisotropically etched with potassium hydroxide. In one embodiment this step uses KOH 45% by volume and is performed at 95° C. The etch rate depends upon the doping and crystal orientation of the silicon, and the type/temperature of KOH solution used. Channel 20 is formed by this step. Now referring to FIGS. 1C-1E and FIG. 4, etching the oriented silicon wafers in KOH typically produces wells with angled sidewalls. Where the wafer substrate 10 is oriented, chemical wet etching will produce the channel 20 anisotropically with low aspect ratio. As a result, the channel 20 geometry is trapezoidal as shown in FIG. 1C. However, channels 20 of any shape or size may be employed depending on the application as will be apparent to one having skill in the art. The configuration of channel 20 may be fabricated with varying widths, depths and lengths depending on the application, with widths between 50 to 456 μm being preferred, depths between 35 and 350 μm being preferred and length between 6 and 19 cm being preferred. The separation distance between the channels may be varied to fit the space in which the microheater 2 will be located. FIG. 3 shows a fabricated microheater 2 with channels 20 with two contact pads 40.

Now referring to FIG. 1D, ion implantation is performed wherein dopant atoms 24 are ionized, formed into a beam, and swept across the wafer 10. The bombarding atoms 24 enter the wafer substrate 10 and come to rest below the surface as shown. The dopant is preferably boron.

Now referring to FIG. 1E, optionally a layer of spin on glass (SOG) 28 is applied in said channel. It is expected that in many applications, it would be desirable that channel 20 would be coated with some other material such as glass or polymer. For example, microchannel heaters of the present invention used in electrophoresis and chromatography require glass-based surfaces because of the ease of chemical modification using organosilanes. Since organic polymers have low adhesivity for silicon or metal, a layer of glass can be used on the substrate for modification. Hence, in a preferred embodiment, a SOG layer 28 is applied on the channel 20. The thickness of the SOG layer 28 may be controlled by the speed of the spinner applicator. For example, to achieve a glass thickness of 1 μm on a 6″ wafer, 4 ml of SOG may be applied at 2000 RPM for a period of 2.0 seconds. Variations of this method may be employed to vary thickness of the SOG layer 28. The application step is preferably followed by a baking step such as hard plate baking at 80° C., 150° C. and 250° C. for 40 seconds each. Preferably a curing step is employed wherein the wafer 10 is cured in a furnace, optimally at 425° C. for 60 minutes for a 1 μm SOG layer. Variations in temperature and time may be necessary depending on the equipment used, wafer composition, SOG thickness, conductor type and the like as will be apparent to one having skill in the art.

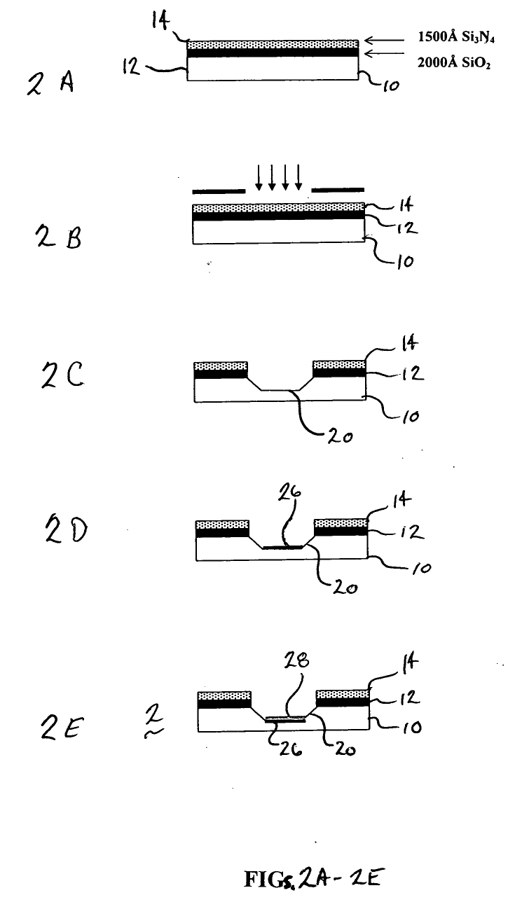

Now referring to FIGS. 2A-2E in a preferred embodiment a microheater 2 is formed whereby a conductor 26 is deposited in channel 20 instead of ion implantation as in FIGS. 1D-1E. Referring to FIGS. 2A-2C the identical steps are performed for preparing the wafer 10 and forming channel 20 as in FIGS. 1A-1C. In FIG. 2D, however, deposition of a conductor 26 such as but not limited to a metal in the channel 20 by sputtering is performed. Conductor 26 may be any suitable conducting material such as but not limited to iron, copper, aluminum, chromium, gold, silver, platinum or the like, alloys thereof, composites of organic conducting polymers and metals and the like. Conductor 26 may be substituted by a suitable organic conducting polymer. In a most preferred embodiment the conductor 26 is an aluminum alloy comprising 99% aluminum, the rest being silicon and copper. Silicon-aluminum alloys prevent the silicon from reacting with the deposited aluminum, which could cause spiking or short circuits.

Microfabricated heaters made in accordance with the preceding discussion may be tested such as by mounting under a four-point probe station, commercially available from Cascade Microtech Inc., Beaverton, Oreg., and applying different voltages to the device to test the heating characteristics as a function of time. A Tegam 871 digital thermometer in conjunction with Kapton p08508-86 K thermocouple probe can be placed on contact pads to measure the temperature of channel 20.

### EXAMPLE 1

The resistance, R, of the circuit element can be computed as:

R=γL/tb (1)

where γ is the resistivity of conducting material, t is the thickness of the conducting material, L is the overall length of channel, and b is the width of channel.

The different channel configurations shown in the Table 1 were fabricated on a single wafer to study the heating characteristics. The heater was formed by depositing a 1 μm of conducting film consisting of an alloy of aluminum (99%) and silicon and copper (1%) on the channels.

TABLE 1
Experimental resistances of the microheaters of different
dimensions, and the maximum temperature reached at 40 V.

| | | | | Maximum | |
|---|---|---|---|---|---|
| | | | | temperature, ° C. | |
| Heater | b | L | Resistance of metal film | Metal | Metal film + |
| Type | μm | μm | Rₑ², Ohm | film | SOG† |
| A | 456 | 6.7 | 5.8 | 387 | 131 |
| B | 300 | 6.0 | 14.2 | 247 | 52 |
| C | 456 | 18.7 | 21.0 | 137 | 41 |
| D | 50 | 6.0 | 40.0 | 86 | 31 |

²Rₑ is an experimental resistance.
†Metal thickness is 1 μm and SOG thickness is 0.7 μm.

Theoretical resistance, can be calculated based on known resistivity, thickness of conducting material and its dimensions. The experimental resistance is shown on Table 1.

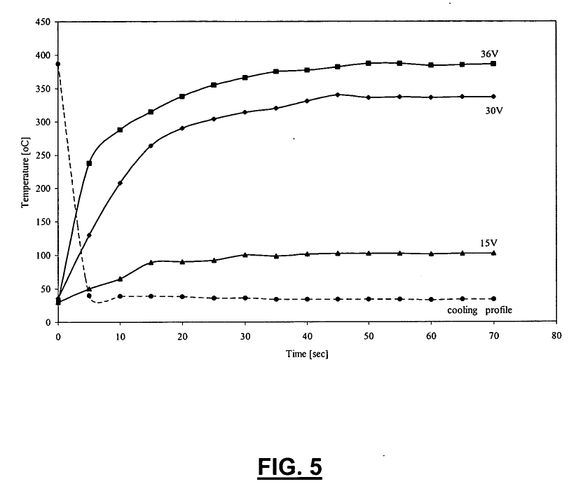

The heating characteristics of microheater 2 at different voltages as a function of time was studied. The initial temperature was between 23 and 25° C. for all the heaters. The temperature profile of heater A with 15, 30, and 36 volts across it are shown in FIG. 5, a temperature profile of heater type A with 1 μm metal film when different voltages were applied. It was observed the microheaters cooled faster than they heated up. Specifically, each microheater took an average 10 to 20 seconds to reach the maximum temperature but less than 5 seconds to cool down to its initial temperature. All heat was lost to surrounding air and through the silicon body of the heater. In all cases, temperature stabilized in less than 30-seconds. Table 1 shows the maximum temperatures attained for different heater designs. As shown in FIG. 5 and in Table 1, the temperature in excess of 350° C. could be achieved with approximately 36V. It should be noted that higher temperatures can be reached by applying higher voltage or changing film thickness.

### Experiment 2

A set of microheaters was made by low dose boron implantation in accordance with the method of FIGS. 1A-1E. The resistance was a function of dopant concentration. The wafers were annealed at 400° C. in presence of argon. The annealing brought some of the dispersed dopant ions closer to the surface, thus forming a uniform conductive layer. Inadequate annealing could result in a bulk of the implanted ions being distributed too deep into the substrate to contribute to conductivity. Two different implantation regimes were used. Furthermore, in an effort to improve heating characteristics, each was subjected to two different anneal times.

In order to arrive at the proper energy and dose of the boron source, the concentration following the annealing was simulated using a computer program called SUPREME III (Stanford University Process Emulator). This determined the penetration depth of the boron atoms. For the first run, implantation energy was 80 keV at a dose of 1×10¹⁴ atoms/cm³. For the second run, implantation was at a higher dose, 2×10¹⁵ atoms/cm³, and at 100 keV. After annealing (dopant activation), boron ions come to rest at various depths in the wafer. They are centered about a depth called the projected range at which diffusion depth can be predicted.

The sheet resistances after boron implantation were measured. The computed and measured total resistances are listed in Table 2. The resistances with boron doping were much higher than those obtained by metal deposition. For the first implant (80 keV, 1×10¹⁴/cm², 40 min anneal at 900° C.), the concentration was 5×10¹⁹/cm³ at a depth of 0.4 μm with γ of 1.8×10⁻³ Ω-cm. For the second implant (100 keV, 2×10¹⁵/cm², 20 min anneal at 1050° C.), the concentration was 1×10²⁰/cm³ a depth of 1 μm with γ of 5×10⁻⁴ Ω-cm. The second scheme brought about an order of magnitude decrease in the resistance of the channels. A higher dose of doping for example in the range of 10×10¹⁹/cm³ to 10²¹/cm² would decrease the resistance further.

TABLE 2
Resistances of boron implanted channels

| Heater | Rₑ (kΩ) - implant at 80 keV, | Rₑ (Ω) - implant at 100 keV, |
|---|---|---|
| Type | 1 × 10¹⁴/cm², 900° C. | 2 × 10¹⁵/cm², 1050° C. |
| A | 0.54 | 66.7 |
| B | 1.95 | 125 |
| C | 25.5 | 1600 |
| D | | 73 |

Table 3 shows the maximum temperature attained by different fabricated heaters under different annealing conditions. It shows that annealing beyond 20 minutes did not increase the maximum attainable temperature by the heaters.

The heating profile of the doped wafer was similar to the heaters with the metallic layer. The conductivity depends on the dopant concentration.

TABLE 3
Maximum Temperature Measured [° C.] for the
boron implanted heaters at 40 Volts.

| | BORON | | | |
|---|---|---|---|---|
| | Implanted, annealed | | | |
| Heater | 80 keV | 80 keV | 100 keV | 100 keV |
| Type | 1 × 10¹⁴/cm² | 1 × 10¹⁴/cm² | 2 × 10¹⁵/cm² | 2 × 10¹⁵/cm² |
| Diffusion | 40 min annealing | 60 min annealing | 20 min annealing | 40 min annealing |
| Depth | 0.3 μm | 0.4 μm | 1 μm | 1.2 μm |
| A | 32.8 | 36.6 | 64.3 | 62.0 |
| B | 25 | 26.1 | 44.0 | 38.1 |
| C | 26.7 | 26.7 | 26.0 | 27.3 |
| C | 25 | 25.9 | 40.3 | 40.4 |

### Experiment 3

Effect of Glass Coating SOG was applied on the channels to see how it affected the temperature characteristics. A glass thickness of 1 μm was applied to the microchannels employing aluminum alloy conductors in accordance with FIG. 2E. This was followed by hard plate baking at 80° C., 150° C. and 250° C. for 40 seconds each. Then the wafers were cured in a furnace at 425° C. for 60 minutes.

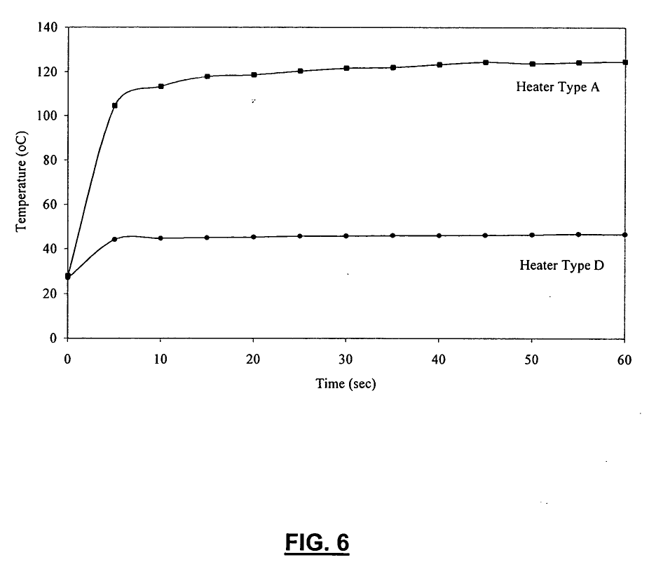

The rise in temperature as a function of time with the spin-on glass coating are presented in FIG. 6 which shows temperature characteristics of 1 μm metal deposited heater type A and D with Spin-On-Glass, at an applied voltage of 43 V. In all cases, the temperature stabilized in less than 10 seconds. A thinner glass layer will permit the microheater of the present invention to attain higher temperatures.

Stability

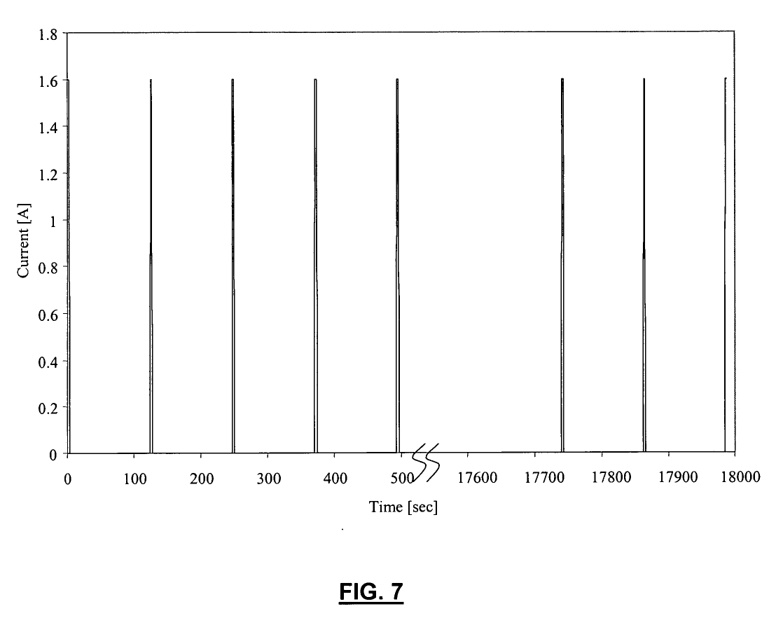

It has been found the microchannel heaters of the present invention, especially those having the characteristics of type A in Table 1, present high stability to heating and cooling. Stability of the heater to alternate heating and cooling was studied by applying a series of repeated voltage pulses. A sequence of 2 seconds, 30 V pulses was applied to heater A, and the current was measured. This was repeated every two minutes for five hours. The results are shown in FIG. 7, a current profile for each voltage pulse to the heater type A; 30 V pulses were applied every 2 minutes for a period of 2 seconds. The heater was able to reach a constant current of 1.6 A for each voltage pulse. The temperature was as high as 100° C. within two seconds. The resistance of the heater did not change during the 148 cycles performed. In another set of experiments, the heater was cycled for seventeen hours (overnight). The current remained the same even after 486 cycles. The relative standard deviation in current of the 148 cycles was 0.620 %. These demonstrate the ruggedness of the microchannel heater of the present invention during repeated cycling.

Modeling and Design of Microheaters

Classical heat transfer theory was used to develop a model for the microheater. This was used to predict temperature characteristics for heaters of different dimensions. Heat generated by electric current in the aluminum film is:

q_{G}=I²γL (2)

where I is the electric current, γ is the electric resistivity of the heating element, and L is the length of the heating film.

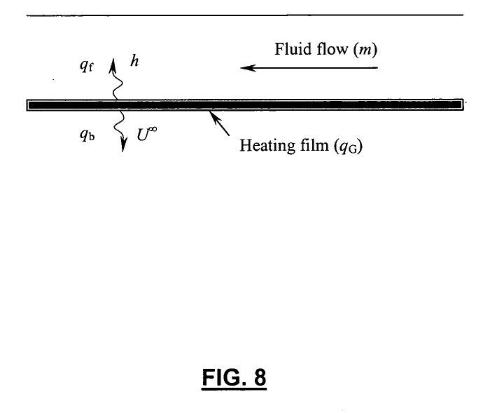

The heat generated is lost through the heater body to the surrounding by conduction (q_{c}) and radiation (qᵣ), and to the flowing fluid (gas or liquid) by convection (q_{f}), as shown in FIG. 8, a schematic diagram of a heater used for the heat transfer modeling:

| | | |
|---|---|---|
| where | qₗₒₛₜ = q_{c} + qᵣ + q_{f} | (3) |
| | q_{c} = ks(Tₕ − T_{∞}) | (3a) |
| | qᵣ = σεtb(Tₕ⁴ − T_{∞}⁴) | (3b) |
| | q_{f} = htb(Tₕ − T_{∞}) | (3c) |

Here, k and s are the heat conductivity and thickness of the silicon substrate respectively, ε and σ are the emittance and the Stefan-Boltzmann constant respectively, h is the convective coefficient for heat transferred to a fluid, and Tₕ and T_{∞} are temperatures of the heating film and the surrounding air.

The Equation (3b) can be linearized by factoring the term (Tₕ⁴−T_{∞}⁴) to obtain an approximate solution:

qᵣ=σεtb(Tₕ⁴−T₂₈ ⁴)=σεtb(Tₕ²+T_{∞}²)(Tₕ+T₂₈)(Tₕ−T₂₈)

In the practical temperature range (up to 400° C.) and with an approximation about ±7% this equation can be written as:

qᵣ≈σεtb(4.3Tₘ³)(Tₕ−T_{∞}) (3d)

Substituting Equations (3a), (3c) and (3d) into Equation (3) it becomes:

qₗₒₛₜ=ks(Tₕ−T_{28 )+σε}tb(4.3Tₘ³)(Tₕ−T_{∞})+htb(Tₕ−T_{∞}) qₗₒₛₜ={ks+σεtb(4.3Tₘ³)+htb}(Tₕ−T_{∞}) (3e)

or

qₗₒₛₜ=U^{∞}tb(Tₕ−T_{∞}) (4)

where

U^{∞}=ks/tb+σε(4.3Tₘ³)+h

is the overall heat transfer coefficient that reflects overall heat loss to the surrounding and includes conductive, radiation, and convective terms. Calculations show that values of radiation heat transfer coefficient σεtb(4.3Tₘ³) contribute only about 0.0003% to the total value of U^{∞} and for practical reason can be neglected. Thus, the heat is mainly lost by conduction and convection transfer.

Substituting Equations (2) and (4), into the Equation (3)

I²γL=U^{∞}tb(Tₕ−T_{∞}) (5)

and considering the Ohm's law I=V/R, Equation (1), and Equation (5) can be written in terms of applied voltage as:

V²b²t²/γL=U^{∞}bL(Tₕ−T_{∞}) (6)

From this, the temperature of the heating film Tₕ, can be calculated as

Tₕ=V²bt²/γU^{∞}L²+T_{∞} (7)

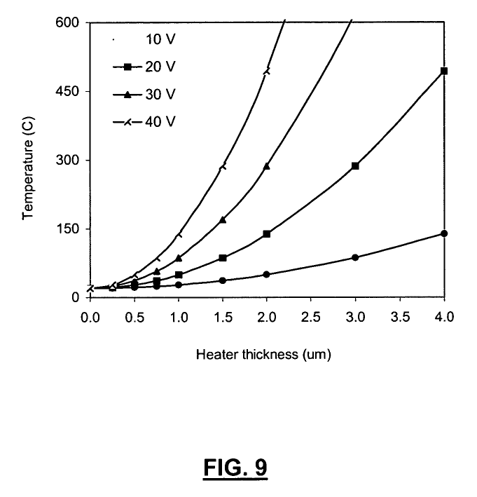

Equation 7 was used to calculate the temperature of the heater film as a function of applied voltage to the heater A. This is shown in FIG. 9, a calculated temperature as a function of aluminum film thickness (film width 250 μm, length 10 cm). The experimental values of the heater temperature are well represented by this model, thus classical methods of heat transfer can be applied for further heater simulation. The calculated values of the overall heat transfer coefficient, U^{∞}, and experimental temperatures for different types of heaters, A, B, C, and D, ranged from 6×10⁶ to 1×10⁵ W/m²K and are shown in Table 4. These are well within the range of variability commonly encountered in heat transfer calculations.

TABLE 4
Calculated values of the overall heat transfer coefficient,
U^{∞} (no fluid flow).

| | Heater type | | | |
|---|---|---|---|---|
| | A | B | C | D |
| U^{∞}, W/m²K | 1.6 × 10⁵ | 2.1 × 10⁵ | 6.0 × 10⁶ | 1.0 × 10⁵ |

As the conduction and convection coefficients, the value of U^{∞} depends on temperature, fluid properties and flow conditions, the channel geometry. In addition, the dimensions and the uniformness of the deposited heating film sometimes can be difficult to control. Therefore, the predicted temperatures can vary from experimental values, which is often the case in heat transfer calculations. In addition, the heat transfer equation can be used in design of this type of heaters.

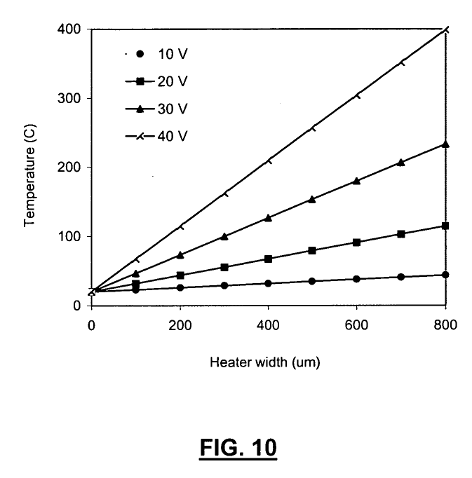

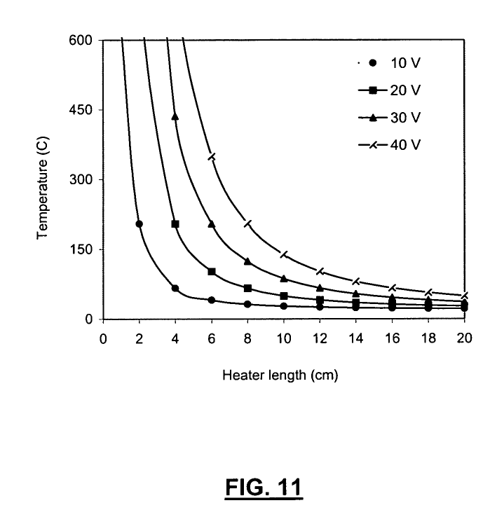

The Equation (7) was used to simulate the microheater temperatures as a function of film dimensions, such as, thickness, width and length. Aluminum was used as the material for the heating film. However, these calculations can be performed for any other material, whose resistivity is known. The calculated film temperatures are shown in FIG. 9, FIG. 10, a calculated temperature as a function of aluminum film width (film thickness 1 μm, length 10 cm), and FIG. 11, a calculated temperature as a function of aluminum film length (film width 250 μm, thickness 1 μm), which can be used for estimating the heater parameters. The effect of film thickness and length on the film temperature is much higher than effect of film width, as can be expected from their squared values in Equation (7). The temperature increases exponentially with the increase in film thickness, and linearly with increase of the film width, which is shown in FIGS. 9 and 10, respectively. The higher the applied voltages, the greater the increase in temperature. The effect of the film length on temperature is more significant in short film heaters (less than 8-10 cm). The heater temperature drops dramatically with the increase in its length, as shown in FIG. 11, a calculated average temperature of air stream as a function of air volumetric flow. Can be varied by channel dimensions (film width 250 μm, thickness 1 μm, length 10 cm, temperature 300° C.). At lower voltages the change in the temperature is more significant.

When the heater is used to heat a flowing gas or a solution, the outlet temperature of the heated fluid, Tₒᵤₜ, can be calculated as:

Tₒᵤₜ=Tₕ−(Tₕ−Tᵢₙ)e^{-hbL/mc} (8)

or

Tₒᵤₜ=Tₕ−(Tₕ−Tᵢₙ)e^{-hbLp/Fc} (8a)

where Tᵢₙ is the inlet fluid temperature, h is convective heat transfer coefficient, m is the fluid mass flow, and c is the fluid heat capacity, p is the fluid density, and F is the volumetric fluid flow. The convective heat transfer coefficient, h, depends on the physical properties of the fluid, its flow characteristics, and can be estimated as:

h=kNu/D (9)

where k is the thermal conductivity for the fluid, Nu is the Nusselt number, and D is the channel diameter. The Nusselt number, Nu, for a fluid flow along a heated film can be calculated as:

Nu=0.332Pr^{1/3}Re^{1/2} (10)

where Pr is the Prandtl number [36], and Re is the Reynolds number:

Re=VL/v (11)

or

Re=4FL/πvD² (12)

where V is the fluid velocity, and v is the fluid kinematic viscosity, and F is the fluid volumetric flow.

Combining Equations (9), (10) and (11), Equation (12) becomes

h=0.664kPr^{1/3}(FL/πv)^{1/2} (13)

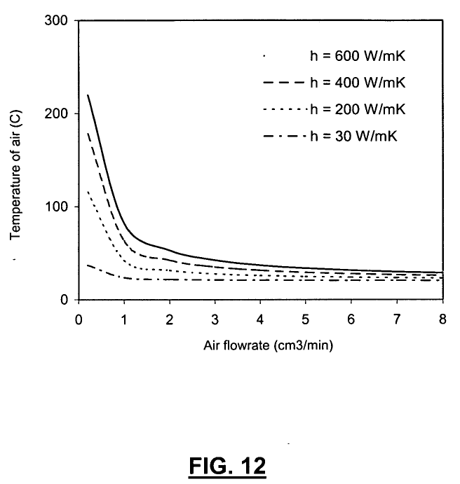

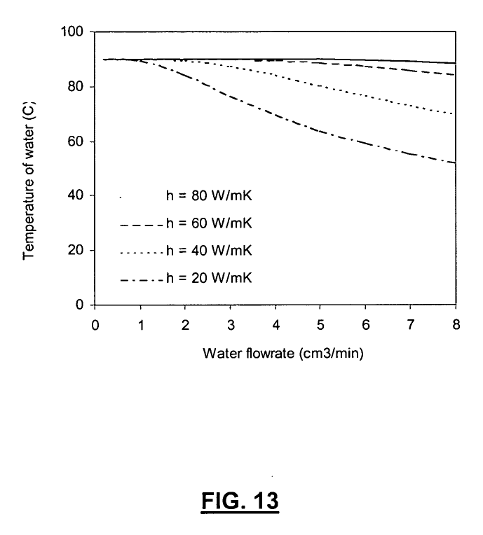

The heat transfer coefficient, h, depends upon the fluid, its flowrate, and the heater characteristics, and needs to be estimated for a particular heater design. Heat transfer coefficient and fluid flowrate affect fluid temperature in these heaters. FIGS. 12 and 13 are simulations of average temperature as a function of gas and liquid flowrate at different values of h. As can be seen from FIG. 12 the air temperature drops sharply with the increase of gas flowrate. This drop in temperature is more significant at higher values of heat transfer coefficients. At high flowrates (more than 4-5 ml/min) the effects of flowrate and heat transfer coefficient are insignificant, which means that efficiency of this particular heater is low and some of channel or heating film dimensions must be reviewed.

However, the heater is more effective for liquids, such as aqueous solutions. As shown in FIG. 13, a calculated average temperature of water as a function of water volumetric flow (film width 250 μm, thickness 1 μm, length 10 cm, temperature 90° C.), average water temperature is high at even high flowrates, which is due to high heat capacity of water. The water temperature can be further increased by increasing the heater film thickness or channel width.

While the preferred embodiments have been described and illustrated it will be understood that changes in details and obvious undisclosed variations might be made without departing from the spirit and principle of the invention and therefore the scope of the invention is not to be construed as limited to the preferred embodiment.

What is claimed is:

1. A microheater for microfluidic devices comprising a microchannel formed on a substrate and further comprising a conductor disposed in said microchannel.

2. A microheater according to claim 1 said conductor selected from the group consisting of metal, metal alloys, composites of organic conducting polymers and metals and organic conducting polymers; and implanted ions.

3. A microheater according to claim 2 said conductor comprising an aluminum alloy comprising 99% aluminum and silicon and copper.

4. A microheater according to claim 2 said conductor comprising implanted boron ions.

5. A microheater according to claim 1 said substrate comprising a wafer.

6. A microheater according to claim 1 said substrate comprising quartz.

7. A microheater according to claim 1 said substrate comprising borosilicate glass.

8. A microheater according to claim 1 said substrate comprising an oriented, boron doped, single side polished silicon wafer.

9. A microheater according to claim 1 further comprising a glass layer disposed on said conductor.

10. A microfluidic device comprising a microchannel, said microchannel further comprising a microheater, said microheater comprising a conductor layer formed in said microchannel.

11. The device according to claim 10 said conductor selected from the group consisting of metal, metal alloys, composites of organic conducting polymers and metals and organic conducting polymers; and implantated ions.

12. The device according to claim 10 said microchannel comprising a channel formed on a substrate said substrate selected from the group consisting of quartz and borosilicate wafers.

13. A microheater according to claim 10 further comprising a glass layer disposed on said conductor layer.

14. A method for fabricating a microheater for a microfluidic device comprising the steps of:
providing a substrate;
patterning said substrate;
forming a channel in said substrate; and
forming a conductor in said channel.

15. The method according to claim 14, said step of forming said channel comprising etching said substrate.

16. The method according to claim 14, said step of forming said conductor comprising ion implantation.

17. The method according to claim 16, said ion implantation step comprising implanting in said channel boron.

18. The method according to claim 14, said step of forming said conductor comprising forming a metal, metal alloy, organic conducting polymer or polymer-metal composite in said channel.

19. The method according to claim 14 said step of forming said conductor comprising sputtering aluminum or an alloy thereof in said channel.

20. The method according to claim 14 comprising the further step of applying a layer of glass over said conductor.
